(19) United States
(12) Patent Application Publication
(10) Pub. No.: US 2011/0048680 A1
(43) Pub. Date: Mar. 3, 2011

(54) HEAT DISSIPATION MODULE

(75) Inventor: RUNG-AN CHEN, Tu-Cheng (TW)

(73) Assignee: FOXCONN TECHNOLOGY CO., LTD., Tu-Cheng (TW)

(21) Appl. No.: 12/604,412

(22) Filed: Oct. 23, 2009

(30) Foreign Application Priority Data
Aug. 31, 2009 (CN) 200910306357.1

(51) Int. Cl. F28D 15/02; F28D 21/00; G06F 1/20

(52) U.S. Cl. 165/104.26; 165/121

(57) ABSTRACT

A heat dissipation module includes a centrifugal fan, a fin assembly and a heat pipe. The centrifugal fan defines an air outlet and a cutout at the air outlet of the centrifugal fan. The fin assembly includes a plurality of fins arranged together and is located at the air outlet of the centrifugal fan. The fin assembly defines a first air inlet communicating with the air outlet of the centrifugal fan. The fin assembly forms a protruding portion being located at the cutout of the centrifugal fan. The protruding portion defines a second air inlet communicating with the air outlet of the centrifugal fan. The heat pipe is thermally attached to the fin assembly.

### BACKGROUND

1. Technical Field

The present disclosure relates to heat dissipation modules, and particularly to a heat dissipation module suitable for use in a device such as a notebook computer for dissipating heat of heat-generating electronic components of the notebook computer.

2. Description of Related Art

With continuing development of notebook computer technology, heat-generating electronic components such as CPUs (central processing units) are generating more and more heat which requires immediate dissipation. Generally, heat dissipation modules are attached to the electronic components to provide such heat dissipation. A conventional heat dissipation module includes a fin assembly, a heat pipe and a centrifugal fan. The heat pipe thermally connects the electronic component with the fin assembly to transfer heat from the electronic component to the fin assembly. The centrifugal fan defines an air outlet where the fin assembly is located and provides a forced airflow to cool the fin assembly. However, many modern notebook computers generate a great deal of heat. A conventional heat dissipation module may not be able to efficiently dissipate very large amounts of heat.

Therefore, a heat dissipation module is desired to overcome the above described shortcoming

### BRIEF DESCRIPTION OF THE DRAWINGS

FIG. 1 is an assembled, isometric view of a heat dissipation module in accordance with an embodiment of the present disclosure.

FIG. 2 is an exploded view of the heat dissipation module of FIG. 1.

FIG. 3 is an isometric view of a fin assembly of the heat dissipation module of FIG. 1.

FIG. 4 is an isometric view of the fin assembly of FIG. 3, viewed from another aspect.

### DETAILED DESCRIPTION

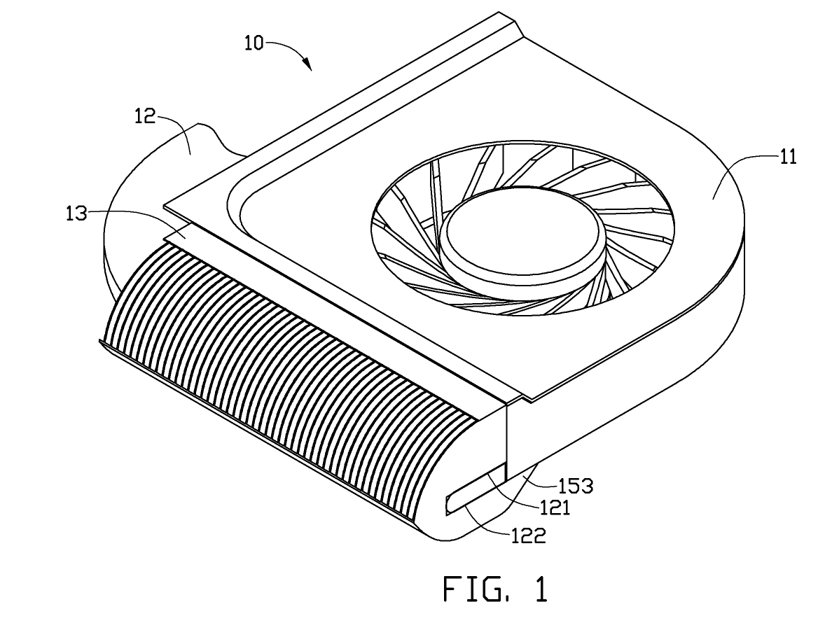

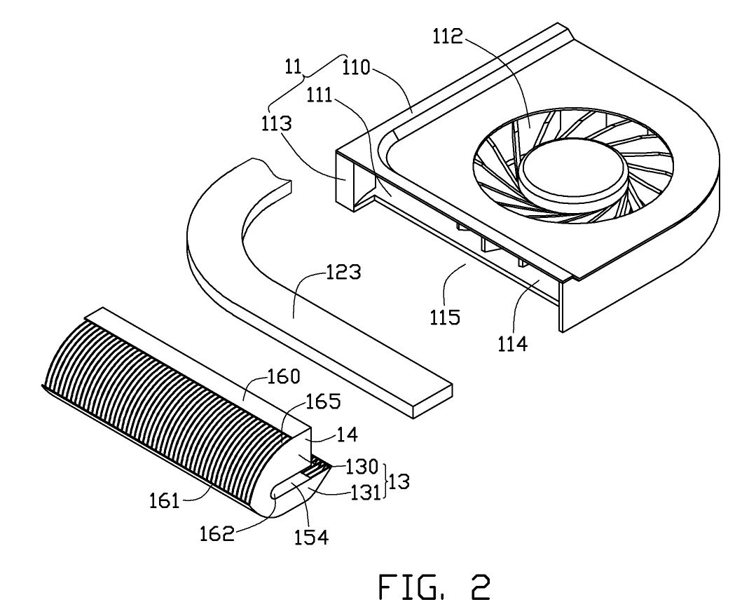

FIGS. 1-2 show a heat dissipation module 10 in accordance with an embodiment of the present disclosure. The heat dissipation module 10 includes a centrifugal fan 11, a heat pipe 12, and a fin assembly 13. The heat dissipation module 10 is particularly suitable for use in a notebook computer for dissipating heat of heat-generating electronic components of the notebook computer.

The centrifugal fan 11 includes a top plate 110, a bottom plate 111 and a sidewall 113 interconnecting the top plate 110 with the bottom plate 111. The centrifugal fan 11 defines an air inlet 112 at the top plate 110 and an air outlet 114 at the sidewall 113, wherein the air outlet 114 is perpendicular to the air inlet 112. The bottom plate 111 of the centrifugal fan 11 defines a cutout 115 at the air outlet 114 of the centrifugal fan 11. The heat pipe 12 is flat, including a planar top surface 121 and a planar bottom surface 122. The heat pipe 12 includes an evaporating section for absorbing heat from an electronic component of the notebook computer, and a condensing section 123 located at a bottom side of the air outlet 114 of the centrifugal fan 11.

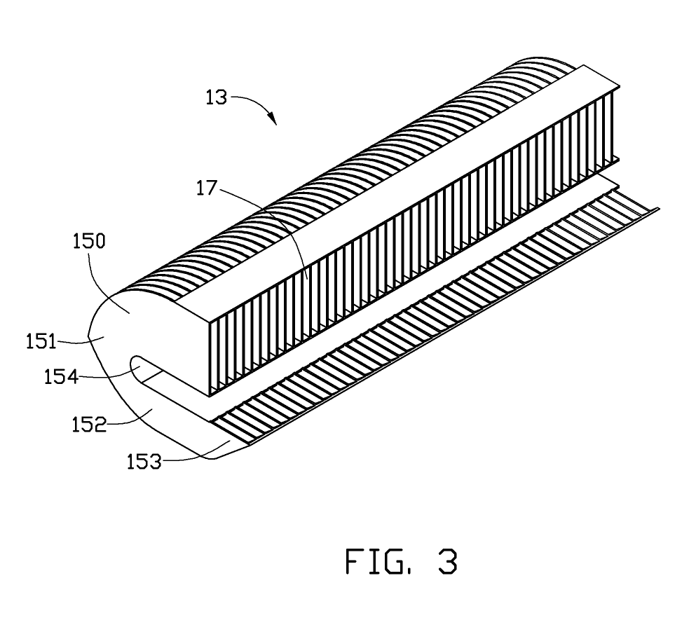

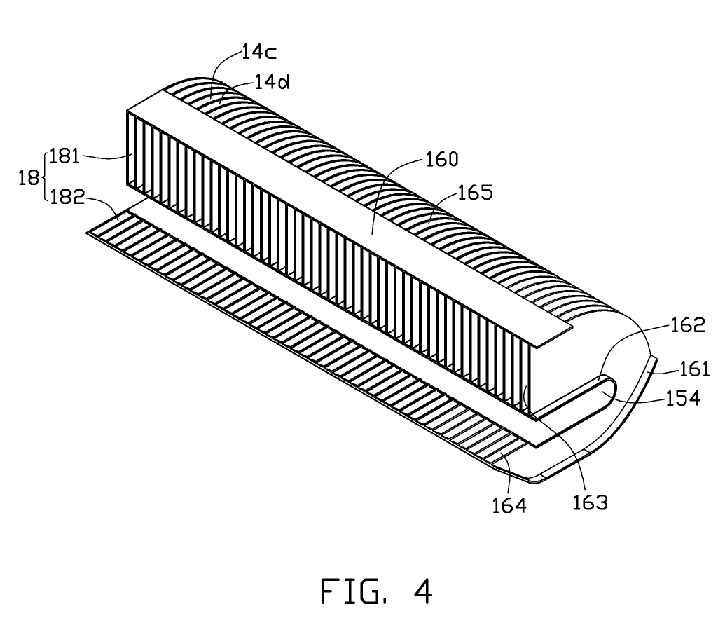

Referring also to FIGS. 3-4, the fin assembly 13 is located at the air outlet 114 of the centrifugal fan 11 and includes a plurality of parallel fins 14 arranged closely together along the condensing section 123 of the heat pipe 12. An air passage 17 is defined between every two neighboring fins 14 of the fin assembly 13. The air passages 17 cooperatively define an air channel 18 for the fin assembly 13.

The fin assembly 13 includes a first horizontal portion 150 at a top side of the fin assembly 13, a second horizontal portion 152 at a bottom side of the fin assembly 13, a connecting portion 151 at a rear side of the fin assembly 13, and a protruding portion 153 extending from a front side of the second horizontal portion 152 to the cutout 115 of the centrifugal fan 11. The connecting portion 151 is outwardly curved and connects between the first horizontal portion 150 and the second horizontal portion 152. The first horizontal portion 150, the connecting portion 151 and the second horizontal portion 152 are arranged in a C-shaped profile and accordingly provide for a receiving slot 154. The receiving slot 154 generally separates the fin assembly 13 into an upper part 130 and a lower part 131. The upper part 130 includes the first horizontal portion 150. The upper part 130 faces the air outlet 114 of the centrifugal fan 11. The lower part 131 includes the second horizontal portion 152 and the protruding portion 153. The lower part 131 of the fin assembly 13 is located below the bottom plate 111 of the centrifugal fan 11. The protruding portion 153 is located at the cutout 115 of the centrifugal fan 11. A bottom of the protruding portion 153 is inclined upwardly toward the centrifugal fan 11. Thereby, a height of the protruding portion 153 decreases from a rear end thereof to a front end thereof.

The fin assembly 13 has a connecting surface 160, a guiding surface 161 and a contacting surface 162. The connecting surface 160 is at the top side of the fin assembly 13, the guiding surface 161 is at the bottom side of the fin assembly 13, and the contacting surface 162 is at the receiving slot 154 of the fin assembly 13. The connecting surface 160 is a planar sheet and seals the top side of the fin assembly 13. The guiding surface 161 is a curved sheet and seals the bottom side of the fin assembly 13. The contacting surface 162 is C-shaped in profile and defines the receiving slot 154. The contacting surface 162 generally separates the air channel 18 into a first air channel 181 at the upper part 130 of the fin assembly 13 and a second air channel 182 at the lower part 131 of the fin assembly 13.

The connecting surface 160 is spaced from the contacting surface 162, thereby defining a first air inlet 163 at a front side of the upper part 130 of the fin assembly 13. The first air inlet 163 faces the air outlet 114 of the centrifugal fan 11. The connecting surface 160 is spaced from the guiding surface 161, thereby defining an air outlet 165 at the top rear side of the fin assembly 13. The guiding surface 161 is spaced from the contacting surface 162, thereby defining a second air inlet 164 at a top side of the protruding portion 153, wherein the second air inlet 164 is perpendicular to the first air inlet 163 of the fin assembly 13. The first air inlet 163 and the second air inlet 164 of the fin assembly 13 are located at the front side of the fin assembly 13 and communicate with the air outlet 165 of the fin assembly 13. The first air channel 181 is defined between the first air inlet 163 and the air outlet 165 of the fin assembly 13. The second air channel 182 is defined between the second air inlet 164 and the air outlet 165 of the fin assembly 13. The first air channel 181 is generally separated from the second air channel 182 by the contacting surface 162.

The condensing section 123 of the heat pipe 12 is received in the receiving slot 154 of the fin assembly 13. The top surface 121 of the heat pipe 12 is attached to a top portion of the contacting surface 162, and the bottom surface 122 of the heat pipe 12 is attached to a bottom portion of the contacting surface 162. The first air inlet 163 of the fin assembly 13 faces the air outlet 114 of the centrifugal fan 11. The first air inlet 163 of the fin assembly 13 thus communicates with the air outlet 114 of the centrifugal fan 11. The protruding portion 153 of the fin assembly 13 is located at the cutout 115 of the centrifugal fan 11. The second air inlet 164 of the fin assembly 13 communicates with the air outlet 114 of the centrifugal fan 11 via the cutout 115.

An airflow generated by the centrifugal fan 11 flows toward the fin assembly 13. A part of the airflow enters the first air inlet 163 of the fin assembly 13, then flows through the first air channel 181, and finally flows out of the fin assembly 13 via the air outlet 165. Another part of the airflow enters the second air inlet 164 via the cutout 115 of the centrifugal fan 11, then flows through the second air channel 182, and finally flows out of the fin assembly 13 via the air outlet 165 of the fin assembly 13.

Heat of the condensing section 123 is transferred to the upper part 130 and the lower part 131 of the fin assembly 13. The airflow flows through the upper part 130 and the lower part 131 of the fin assembly 13 at the same time whereby the heat of the upper part 130 and the lower part 131 is dissipated simultaneously. Furthermore, the lower part 131 (including the second horizontal portion 152 and the protruding portion 153) of the fin assembly 13 is located below the bottom plate 111 of the centrifugal fan 11 whereby a total heat exchange surface area for the fin assembly 13 is greatly increased, while the airflow of the centrifugal fan 11 still can flow smoothly into the lower part 131 of the fin assembly 13 via the second air inlet 164 provided at the protruding portion 153. Thus, a heat dissipating efficiency of the heat dissipation module 10 is greatly improved.

It is to be understood, however, that even though numerous characteristics and advantages of the disclosure have been set forth in the foregoing description, together with details of the structures and functions of the embodiment(s), the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat dissipation module, comprising:
a centrifugal fan defining an air outlet, the centrifugal fan also defining a cutout at the air outlet;
a fin assembly comprising a plurality of fins arranged together and being located at the air outlet of the centrifugal fan, the fin assembly defining a first air inlet communicating with the air outlet of the centrifugal fan, the fin assembly forming a protruding portion, the protruding portion being located at the cutout of the centrifugal fan, the protruding portion defining a second air inlet communicating with the air outlet of the centrifugal fan; and
a heat pipe being thermally attached to the fin assembly.

2. The heat dissipation module of claim 1, wherein the centrifugal fan comprises a bottom plate, the cutout being defined in the bottom plate, the first air inlet of the fin assembly being defined at an upper part of the fin assembly, and the protruding portion being at a lower part of the fin assembly.

3. The heat dissipation module of claim 2, wherein the upper part of the fin assembly faces the air outlet of the centrifugal fan, and the lower part of the fin assembly is located below the bottom plate of the centrifugal fan.

4. The heat dissipation module of claim 1, wherein the fin assembly further comprises a first horizontal portion, a second horizontal portion and a connecting portion, the first horizontal portion is at a top of the fin assembly, the second horizontal portion is at a bottom of the fin assembly, and the connecting portion is at a rear of the fin assembly and connecting the first horizontal portion and the second horizontal portion, the first horizontal portion, the connecting portion and the second horizontal portion cooperatively defining a receiving slot, a condensing section of the heat pipe being received in the receiving slot.

5. The heat dissipation module of claim 1, wherein a bottom of the protruding portion is inclined upward toward the centrifugal fan, whereby a height of the protruding portion decreases from a rear end thereof to a front end thereof.

6. The heat dissipation module of claim 1, wherein the fin assembly defines an air outlet generally at a rear side thereof, the first air inlet and the second air inlet being located at a front side of the fin assembly, a first air channel being defined between the first air inlet and the air outlet of the fin assembly, a second air channel being defined between the second air inlet and the air outlet of the fin assembly, the first air channel being separate from the second air channel at the front side of the fin assembly.

7. The heat dissipation module of claim 1, wherein the first air inlet is substantially perpendicular to the second air inlet.

8. The heat dissipation module of claim 1, wherein the second air inlet of the fin assembly communicates with the air outlet of the centrifugal fan via the cutout.
